(19) United States
(12) Patent Application Publication
(10) Pub. No.: US 2015/0152891 A1
(43) Pub. Date: Jun. 4, 2015

(54) ROTARY CYLINDER

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JU-LAN HAO, Shenzhen (CN)

(21) Appl. No.: 14/537,345

(22) Filed: Nov. 10, 2014

(30) Foreign Application Priority Data
Nov. 30, 2013 (CN) 201310624487.6

(51) Int. Cl. F15B 15/02; F15B 15/20

(52) U.S. Cl. CPC F15B 15/02; F15B 15/20

(57) ABSTRACT

A rotary cylinder is provided. The rotary cylinder includes an electromagnetic valve, a movable end, a cylinder barrel placed below the movable end, a threaded pole, a piston rod placed below the threaded pole, a pressure arm placed over the movable end, and a first elastic element. The threaded pole is coupled with a lower end of the movable end and placed within the cylinder barrel. A portion of the piston rod is placed within the cylinder barrel, and a remaining portion of the piston rod is exposed to the cylinder barrel. The first elastic element is placed over the movable end between the pressure arm and the threaded pole.

### CROSS-REFERENCE TO RELATED APPLICATIONS

This application claims priority to Chinese Patent Application No. 201310624487.6 filed on Nov. 30, 2013, the contents of which are incorporated by reference herein.

### FIELD

The present disclosure relates to cylinders, and particularly to a rotary cylinder.

### BACKGROUND

In order to press a number of different positions distributed in a product by a cylinder, the product needs to frequently move the cylinder to different positions, it is time-consuming and inconvenient.

### BRIEF DESCRIPTION OF THE DRAWINGS

FIG. 1 is an isometric view of a rotary cylinder.

FIG. 2 is an exploded view of the rotary cylinder of FIG. 1.

FIG. 3 is a cross-sectional view of the rotary cylinder of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

Embodiments of the present disclosure will be described with reference to the accompanying drawings.

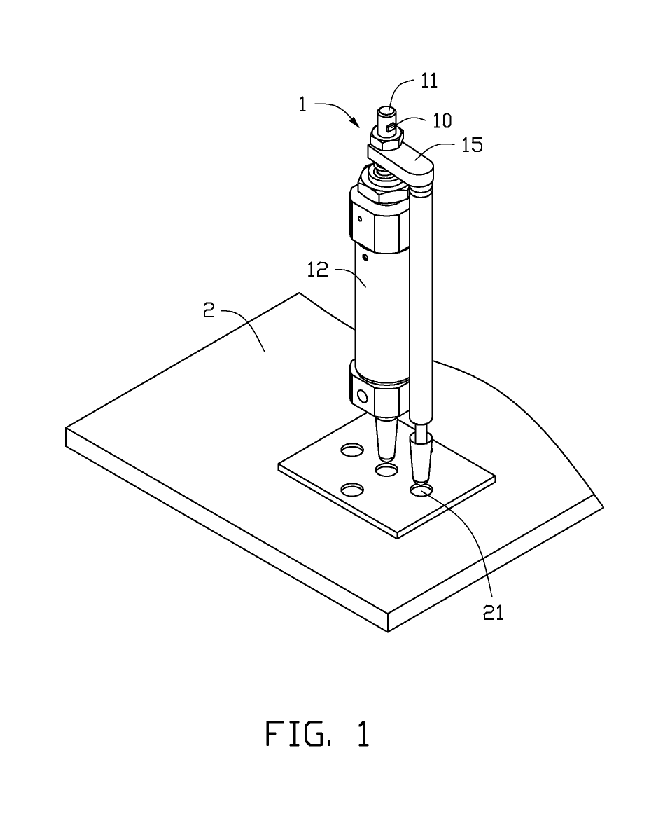

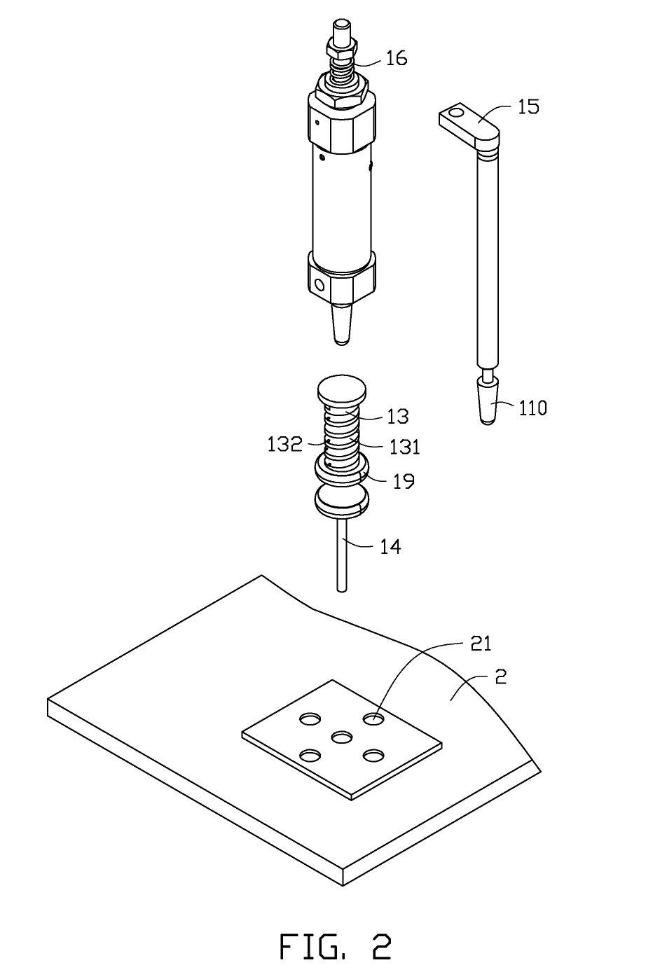

FIG. 1 illustrates a rotary cylinder 1. The rotary cylinder 1 is used to press a number of different testing positions 21 distributed on a product 2. The rotary cylinder 1 includes an electromagnetic valve 10, a movable end 11, a cylinder barrel 12 below the movable end 11, and a pressure arm 15 over the movable end 11. Referring to FIG. 2, the rotary cylinder 1 further includes a threaded pole 13 coupled with to a lower end of the movable end 11 and placed within the cylinder barrel 12, a piston rod 14 placed below the threaded pole 13, and a first elastic element 16 placed over the movable end 11 between the pressure arm and the threaded pole 13. When using the rotary cylinder 1 to press one of the number of testing positions 21, the electromagnetic valve 10 is started up to generate a starting instruction for controlling the moveable end 11 with the pressure arm 15 to move to a position aligned with one of the testing positions 21 in response to a user operation. When the moveable end 11 and the pressure arm 15 moves to the position aligned with one of the testing positions 21, the electromagnetic valve 10 generates a closing instruction for stopping a movement of the movable end 11 with the threaded pole 13 in the cylinder barrel 12. After the movement of the movable end 11 is stopped, the pressure arm 15 is forced by an external force to move downwardly until the testing position 21 is pressed by the pressure arm 15. In one embodiment, the first elastic element 16 is a spring.

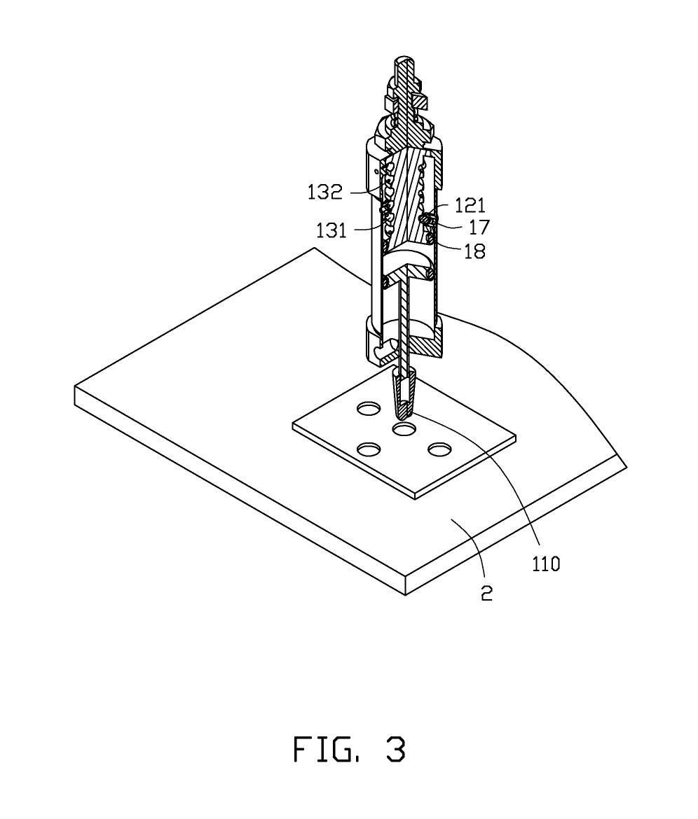

Referring to FIG. 3, the cylinder barrel 12 defines a receiving portion 121 on the sidewall thereof. The rotary cylinder 1 further includes a second elastic element 17 and a ball 18. The second elastic element 17 is substantially received into the receiving portion 121. A portion of the ball 18 is received into the receiving portion 121, and a remaining portion of the ball 18 is exposed to the receiving portion 121. In one embodiment, the second elastic element 17 is a spring.

The threaded pole 13 defines a communicating slot 131 on a lateral surface thereof. The slot 131 receives a number of first sensors 132 into a number of predetermined positions thereof. Each of the number of predetermined positions on the slot 131 corresponds to one of the number of testing portions 21.

The rotary cylinder 1 further includes a piston 19 coupled with a lower end of the threaded pole 13 and a number of second sensors 110. The number of second sensors 110 is coupled with a lower end of the position rod 14 and the pressure arm 15. The number of second sensors 110 is actuated to generate a second signal to an external processing device when the piston rod 14 or the pressure arm 15 presses one of the testing positions 21. The external processing device analyzes the second signal to acquire the testing result for the testing position 21 in the product 2.

When using the rotary cylinder 1 to press the testing positions 21, the electromagnetic valve 10 is started up to generate the starting instruction for controlling the moveable end 11 with the threaded pole 13 to rotatably move downwardly within the cylinder barrel 12 in response to a user operation. During a movement of the threaded pole 13 within the cylinder barrel 12, the ball 18 moves along the slot 131 of the threaded pole 13 until the ball 18 resists one first sensor 132 received into one of the predetermined positions. The first sensor 132 generates a first signal to the electromagnetic valve 10 based on the resisting action from the ball 18. The electromagnetic valve 10 generates the closing instruction for stopping the movement of the movable end 11 with the threaded pole 13 in the cylinder barrel 12 in response to the first signal. Then, the pressure arm 15 is forced by the external force to move downwardly to compress the first elastic element 16 until the testing position, corresponding to the predetermined position which receives the resisted first sensor 132, is pressed by the pressure arm 15.

After the external force applied on the pressure arm 15 is released, the first elastic element 16 rebounds to return the pressure arm 15 to an original position. When wanting to test another testing positions, the electromagnetic valve 10 is started up to generate the starting instruction for controlling the moveable end 11 with the threaded pole 13 to rotatably move downwardly within the cylinder barrel 12 in response to the user operation until the ball 18 resists another first sensor 132 received into another predetermined position, thereby causing the pressure arm 15 to be rotated to different positions and to press the different testing positions 21 in the product 2.

During the movement of the threaded pole 13, the piston 19 is forced by the threaded pole 13 to drive the piston rod 14 to press one of the testing positions 21. Then, the second sensor 100 on the piston rod 14 generates the second signal to the external processing device when the piston rod 14 presses the testing position 21. The external processing device analyzes the second signal to acquire the testing result for the testing positions 21 in the product 2.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A rotary cylinder for pressing a plurality of testing positions distributed in a product, the rotary cylinder comprising:
an electromagnetic valve;
a movable end;
a cylinder barrel below the movable end;
a threaded pole coupled with a lower end of the movable end and within the cylinder barrel;
a piston rod below the threaded pole, wherein a portion of the piston rod is within the cylinder barrel, and a remaining portion of the piston rod is exposed to the cylinder barrel;
a pressure arm over the movable end; and
a first elastic element placed over the movable end between the pressure arm and the threaded pole.

2. The rotary cylinder as described in claim 1, wherein the threaded pole defines a communicating slot on a lateral surface thereof, the slot receives a plurality of first sensors into a plurality of predetermined positions thereof, each of the plurality of predetermined positions corresponds to one of the plurality of testing positions, the cylinder barrel defines a receiving portion on the sidewall thereof, the rotary cylinder further comprises a second elastic element and a ball, the second elastic element is substantially received into the receiving portion, a portion of the ball is received into the receiving portion, and a remaining portion of the ball is exposed to the receiving portion.

3. The rotary cylinder as described in claim 2, wherein the first elastic element and the second elastic element are springs.

4. The rotary cylinder as described in claim 2, further comprising:
a piston coupled with a lower end of the threaded pole.

5. The rotary cylinder as described in claim 1, further comprising:
a plurality of second sensors coupled with a lower end of the piston rod and the pressure arm.
